(19) United States
(12) Patent Application Publication
(10) Pub. No.: US 2007/0076238 A1
(43) Pub. Date: Apr. 5, 2007

(54) Image forming apparatus and data protection method

(75) Inventor: Hiroshi Odagiri, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/231,208

(22) Filed: Sep. 19, 2005

(51) Int. Cl. G06K 15/00

(52) U.S. Cl. 358/1.14; 358/1.15

(57) ABSTRACT

The image forming apparatus of this invention comprises an image processing unit that has a storage device capable of storing image data, and processes and outputs the image data stored in said storage device; and a data protection unit that sets security levels respectively for time slots which are scheduled in advance. The security levels are set high in a time slot in which said image forming apparatus is less frequently used and set low in a time slot in which said image forming apparatus is frequently used, and restrictions are placed on the use of said image data as the security level is high.

### BACKGROUND OF THE INVENTION

1. Field of the Invention

The present invention relates to an image forming apparatus such as an MFP (Multi-Function Peripheral) which is a multifunctional digital device, a copying machine or a printer, and more specifically, relates to an image forming apparatus and a data protection method in which security control is improved by preventing leaks of data.

2. Description of the Related Art

An image forming apparatus such as a multi-function peripheral (MFP) temporarily stores image data in a storage device such as a HDD or an FROM when an print operation is performed, reads the image data from this storage device, and processes the image data by a printer unit to print out images. Also, there are multi-function peripherals (MFP) connected to PCs (Personal Computers) through networks in order to print image data which is created by the PCs.

Incidentally, when multiple copies are printed by an image forming apparatus, image data is temporarily stored in a storage device because the image data has to be repeatedly used. However, since image data remains in the storage device, problems relating to data leakage and so forth are recognized. For example, if important data relating to highly confidential information remains stored in a storage device, it may be taken out from the storage device in the form of image data. Because of this, measures are taken to enhance security by implementing an authentication system and so forth. For example, Japanese Patent Published Application No. Hei 2002-183093 discloses an MFP which authenticates the operator on the basis of a security code, fingerprint information, card information and so forth, and inhibits color copying or impose a limit on the number of printed copies and so forth. However, the procedure becomes cumbersome by a plurality of authentication steps as required.

Also, Japanese Patent Published Application No. Hei 2003-32484 discloses an MFP capable of switching the method of processing data when it detects a keyword such as “confidential” which is added to data to indicate a high level of security. However, there is a shortcoming that the security level is unintentionally lowered if the keyword is inadvertently not added. As has been discussed above, in the case of conventional security systems, a high level of security is inconvenient for the users because of complicated procedures, while the security level is compromised if user-friendliness is improved, and therefore it is difficult to make a tradeoff between the operating efficiency and the security level.

### DESCRIPTION OF THE DRAWINGS

FIG. 1 is a block diagram showing the entire configuration of an image forming apparatus in accordance with an embodiment of the present invention.

FIG. 2 is an explanatory view for showing an example of setting security levels in a data protection unit 15 of the image forming apparatus in accordance with the embodiment of the present invention.

FIG. 3 is an explanatory view for explaining authentication methods which are set respectively for the security levels of the image forming apparatus in accordance with the embodiment of the present invention, and roles in accordance with which image data is encrypted and the use thereof is permitted.

FIG. 4 is an explanatory view for showing the functions enabled respectively corresponding to the roles of the image forming apparatus in accordance with the embodiment of the present invention.

FIG. 5 is a flowchart explaining the process of setting the security levels of the image forming apparatus in accordance with the embodiment of the present invention.

FIG. 6 is a flowchart explaining the process of determining a security level of the image forming apparatus in accordance with the embodiment of the present invention.

FIG. 7 is a flowchart showing the authentication process when logging in the image forming apparatus in accordance with the embodiment of the present invention.

FIG. 8 is a flowchart showing the authentication process before operation after logging in the image forming apparatus in accordance with the embodiment of the present invention.

### DETAILED DESCRIPTION OF THE INVENTION

Throughout this description, the embodiments and examples shown should be considered as exemplars, rather than limitations on the apparatus and method of the present invention. In what follows, an embodiment of the present invention will be explained in detail with reference to drawings.

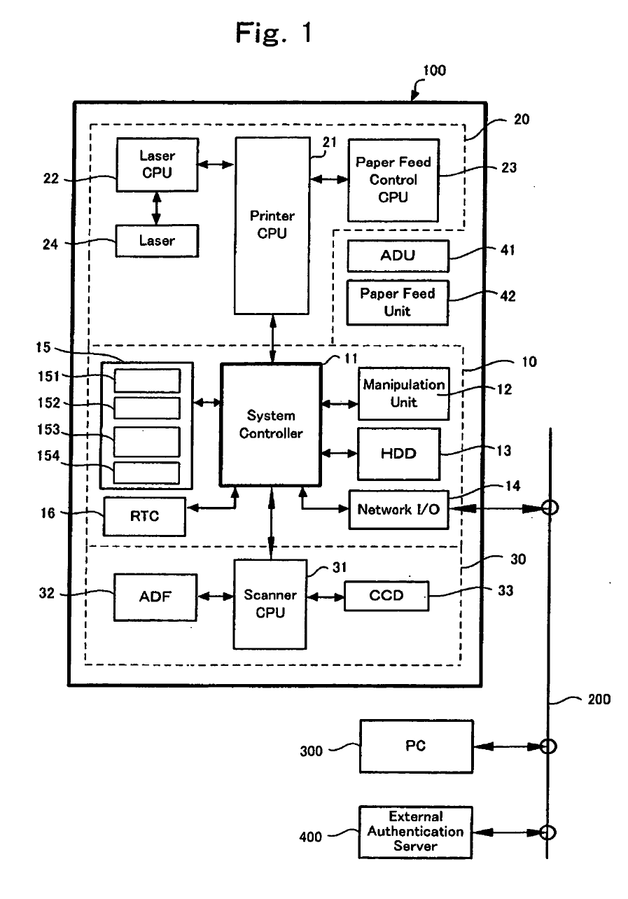

As illustrated in FIG. 1, an image forming apparatus 100 is, for example, an MFP (Multi-Function Peripheral), which is a multifunctional digital device, and connectable to a mobile terminal such as a PC (Personal Computer) 300 and an external authentication server 400 through a network 200 such as a LAN (Local Area Network).

The image forming apparatus 100 includes an image data processing unit 10, a printer unit 20 and a scanner unit 30. The image data processing unit 10 comprises a system controller 11 including software for controlling the operation of the entire system, a manipulation unit 12 connected to the system controller 11, a hard disk drive (HOD) 13 serving as a storage device, and is further provided with a network interface (I/F) 14 for connecting it with the PC 300 and the like through the LAN 200, a data protection unit 15, and a timer 16.

The manipulation unit 12 can be manipulated by a user for inputting the number of print copies, the size of paper and various instructions such as single-side or double-side printing to the system controller 11, and also for inputting a password for authentication. In addition, the manipulation unit 12 is provided with a display panel in which various indications can be displayed.

The HDD 13 is a storage medium which temporarily stores data processed by the printer unit 20 in the form of a print file, data scanned by the scanner unit 30, and other data.

The printer unit 20 has a printer CPU 21, a laser CPU 22 and a paper feed control CPU 23. The respective CPUs 21, 22 and 23 are connected to each other, while the printer CPU 21 controls the operation of the printer unit 20 as well as the system controller 11.

The laser CPU 22 controls a laser 24 in order to control the laser output when a photoreceptor is scanned with a laser beam emitted from the laser 24 in order to generate an image. Also, the paper feed control CPU 23 controls an automatic delivery unit (ADU) 41, a paper feed unit 42, a finisher in order to feed paper in an appropriate manner for single-side or double-side printing.

The scanner unit 30 includes a scanner CPU 31, an automatic document feeder (ADF) 32 and a CCD 33. The scanner CPU 31 controls the scanner unit 30 as well as the system controller 11. The scanner unit 30 irradiates an original placed on a flatbed plate with an exposure lamp, and the reflected light is received by a CCD 33 in order that the image of the original is scanned and converted into image data. Also, the ADF 32 serves to transport originals to the flatbed plate one after another.

Next, the functions of the data protection unit 15 and the timer 16 will be explained. The data protection unit 15 protects data from being leaked by setting the security level of the MFP 100 for each of time slots, which has been scheduled in advance, restricting the use of print data. The data protection unit 15 uses the time information from the timer 16 to set security levels. For example, security is set to a low level in a frequently used MFP 100 time slot, such as weekday or work hours, authenticating users with a simple check. Conversely it sets security to a high level in a less frequently used MFP 100 time slot such as non-work days or late nights, authenticating users with a stringent check. Furthermore, in accordance with the security level, the data is encrypted, and some functions of the MFP 100 are disabled. In this example, one type of authentication, for example, password authentication is used for authenticating users. A real time clock (RTC) can be used as the timer 16.

The data protection unit 15 includes an authentication unit 151, an encryption unit 152, a data erasing unit 153, and a storage unit 154. The authentication unit 151 serves to perform user authentication, the encryption unit 152 serves to instruct, if necessary, the PC 100 to encrypt image data to be transmitted therefrom, and encrypt image data obtained by the scan function of the MFP 100, and the data erasing unit 153 serves to erase the image data, after use, which is temporarily stored in the HDD 13. The encryption unit 152 and the data erasing unit 153 serve as data concealing means in combination. Also, the storage unit 154 is storing means for storing a data table in which security levels to be set are scheduled in correspondence with time slots as defined by dates, days of week, times and so forth which are determined in advance. in association with time slots

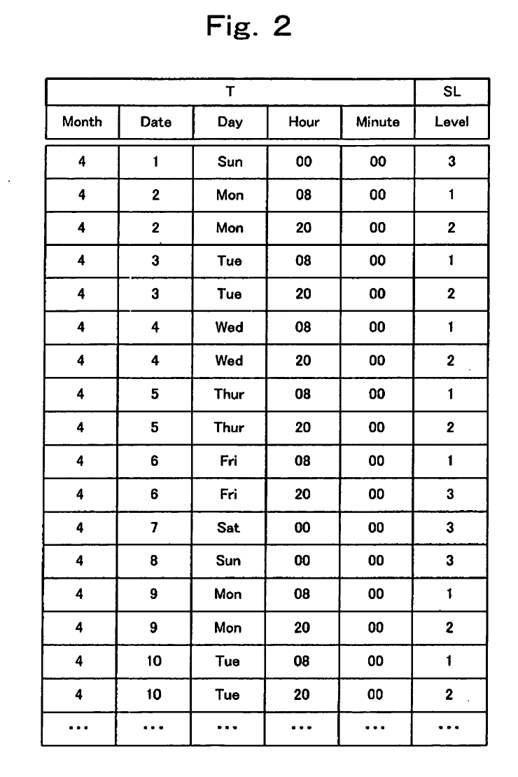

FIG. 2 is a data table containing security levels and timely information in the data protection unit 15. In FIG. 2, “T” indicates a time table, and “SL” indicates security levels. These security levels fall into three different levels including level 1 which is the lowest security level and level 3 which is the highest security level. Level 2 is an intermediate security level.

The security level is set to the lowest security level 1 for office hours (for example, the time slot from 8 AM to 8 PM) from Monday to Friday, and set to the intermediate security level 2 for out of office hours (for example, the time slot later than 8 PM) from Monday to Thursday. On the other hand, the security level is set to the highest security level 3 for out of office hours (for example, the time slot later than 8 PM) on Friday before a holiday, and set to the highest security level 3 through Saturday and Sunday because these days are holidays.

Namely, an attacker who tries to get secret information through security tends to go into the office in the middle of the night or on a holiday when less persons exist and the operation frequency is low, and thereby the security level is set high for such time slots and set low for time slots in which many persons are working and the operation frequency is high.

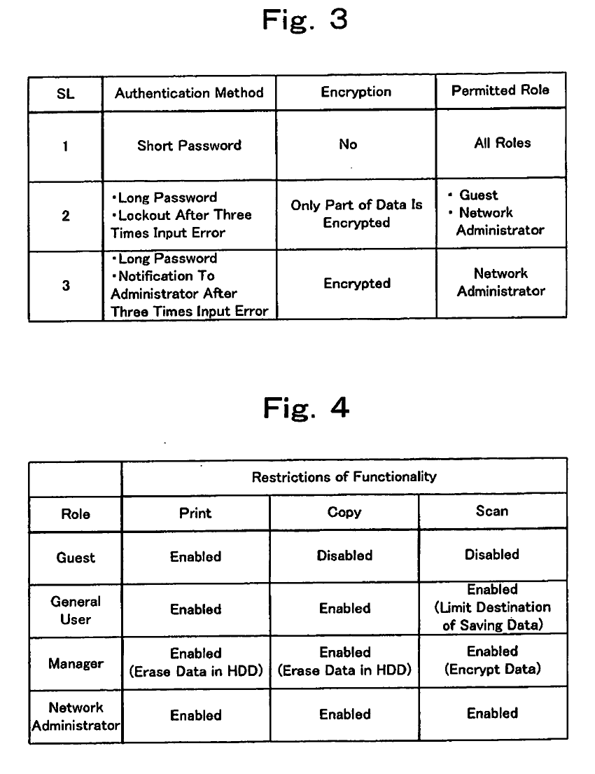

FIG. 3 is a view showing the methods of authentication, the encryption of image data, and roles (to be described below) in accordance with which the use of the MFP 100 is permitted, respectively as set corresponding to the security levels.

For example, in the case of the security level 1, the authentication method is only the confirmation of a short password as input, while the encryption of image data is not required, and the use is permitted for all roles.

Also, in the case of the security level 2, the authentication method is performed by a long password as input, white the use of the MFP 100 is inhibited by lockout when input error is repeated for three times. In the case of the security level 2, only guests and network administrators are permitted to use the MFP.

Furthermore, in the case of the security level 3, the authentication method is performed by a long password as input, and when input error is repeated for three times this fact is reported to a network administrator. In the case of the security level 3, only network administrators are permitted to use the MFP.

In place of the confirmation of a short password or a long password, various types of passwords to be confirmed can be used by combining kinds of available characters and various maximum lengths and so forth in order to make authentication stringent in accordance with the security level as required.

Also, for the purpose of enabling the safe use of data, further measures in addition to the encryption of data can be taken by limiting the ports available for using a data file created by the PC 300 connected to the network, permanently deleting the data lingering on the HDD 13, and so forth, in consideration of the confidentiality of the data to be handled.

Also, the encryption of data is performed by the PC 300 in advance of transmitting the data to the MFP 100, or performed by the MFP 100 in advance of storing image data obtained by the scan function of the MFP 100 in the HDD 13 or an external storage device of the MFP 100.

Furthermore, in the case of the present invention, the users are divided by roles in accordance with which the respective functions of the MFP 100 are selectively enabled and disabled. The roles are used to divide users who use the MFP 100, and include, for example, four classes of “guest”, “general user”, “manager”, “network administrator”. The functions of the MFP 100 are restricted in accordance with the class of the user who is using the MFP 100.

FIG. 4 shows the functions enabled and disabled in accordance with the respective roles. The available functions are “print”, “copy” and “scan”. The “print” function means an operation of processing and printing image data created by the PC 300 and the like, the “copy” function means an operation of scanning an original image by the scanner unit 30 and duplicating the original image by the printer unit 20, and the “scan” function means an operation of scanning an original image and obtaining the image data thereof by the scanner unit 30 and storing the image data obtained by scanning.

As shown in FIG. 4, in the case where the role is “guest”, the “copy” and “scan” functions are disabled while the “print” function is enabled.

Also, in the case where the role is “general user”, the “print”, “copy” and “scan” functions are enabled. However, the destination of the data obtained by scanning is limited to a local folder or a designated folder. In this case, the local folder is a folder created in the HDD 13 of the MFP 100, and the designated folder is a folder of a PC on the network (i.e., a network folder). In other words, the MFP 100 has the capability of saving the data obtained by scanning in either the HDD 13 of the MFP 100 itself or a folder (HDD) of a PC on the network in order to enhance the security by saving the data only in the network folder which is designated by an administrator in advance.

In the case where the role is “manager”, the “print” and “copy” functions are enabled while, when data is printed or copied, the data erasing unit 153 erases the data stored in the HDD 13 once the data is processed. The “scan” function is also enabled while the destination of scan data is not specified but encrypted by the encryption unit 152. A manager class user can freely save scan data to a PC, which he is authorized to access, by designating a network path (together with a user ID and a processed) independently for each job. Namely, the scan data can be saved to a local folder (HDD13) of the MFP 100 or a PC, which he is authorized to access, on a network.

Also, in the case where the role is “network administrator”, the “print”, “copy” and “scan” functions are enabled while the destination of scan data is not restricted.

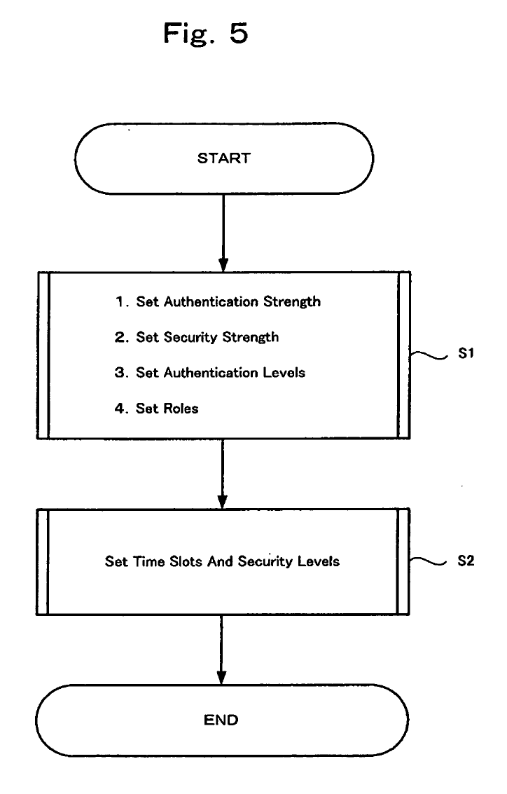

FIG. 5 is a flowchart showing the procedure of setting security levels. First, in step S1, a user (this user has to be authorized as an administrator) performs (1) the setting of authentication strengths for determining authentication accuracy, (2) the setting of security strengths for ensuring the safe use of data as handled, (3) the setting of authentication levels, and (4) the setting of roles and restrictions of functionality for the respective roles. By this configuration, it is possible to define the authentication method for each security level and the use of encryption as shown in FIG. 3 and FIG. 4 and place the restrictions of functionality for the respective roles. Incidentally, the contents as defined and set for the respective security levels are saved in the storage unit 154.

Next, in step S2, the allocation of the security levels is performed on the basis of the time information as shown in FIG. 2. By this configuration, the security levels 1, 2 and 3 are scheduled to the respective time slots which are defined by dates and times.

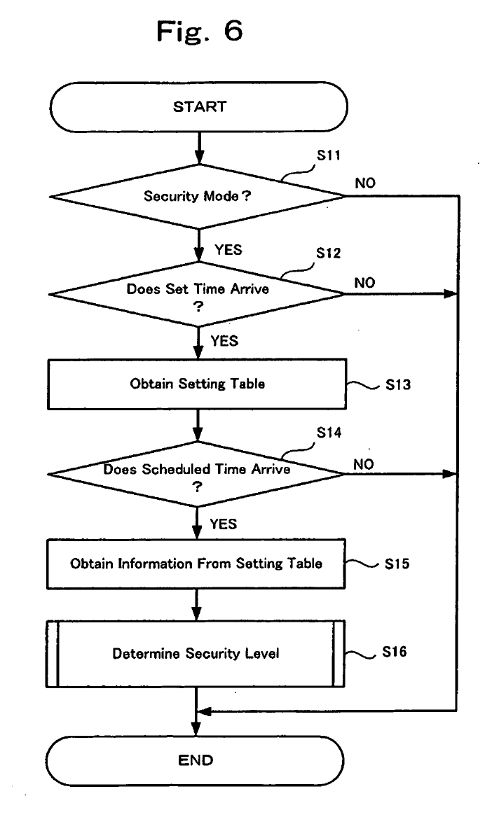

FIG. 6 is a flowchart showing the procedure of determining the security level. In FIG. 6, it is determined in step S11 whether or not the security mode starts. The security mode is a mode in which the security level is set on the basis of time information and the MFP 100 is operated in the security level, but if there is no need for the security mode for example in daily office hours, the security mode is released and the steps after step S11 are skipped in this case.

In the case where the security mode is started in step S11, the MFP 100 continuously monitors the current time with the timer 16 and confirms whether or not the set time arrives in step S12. When a scheduled time arrives, the security level table (hereinafter referred to as the setting table) shown in FIG. 2 is obtained in step S13. Then, in step S14, it is determined whether or not there is a time in the setting table corresponding to the current time, and whether or not the current time is a time in which the security level is to be switched. If there is no corresponding time in the setting table, the process is returned without changing the current settings, and if there is a corresponding time, the security level information corresponding thereto is read from the setting table in step S15 and the security level in which the MFP 100 operates is determined in accordance with the setting table in step S16.

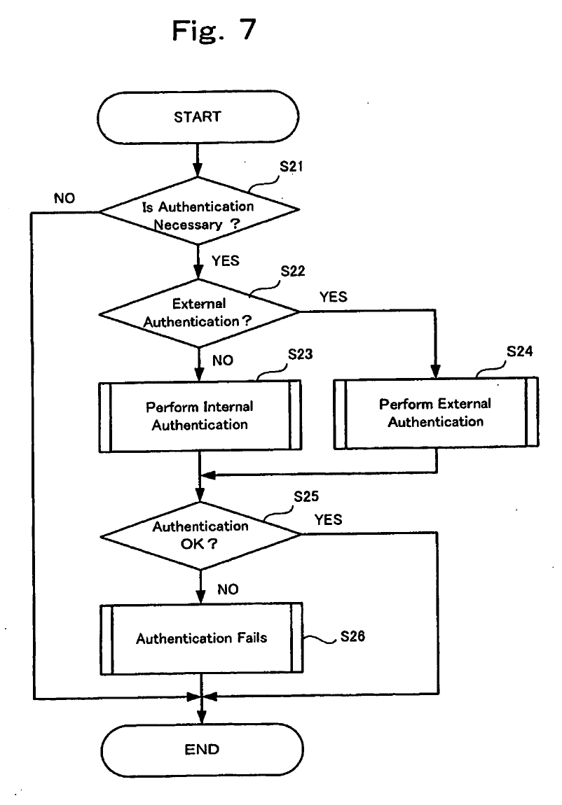

FIG. 7 is a flowchart showing the authentication process when logging in the MFP 100.

In FIG. 7, when a user logs in the MFP 100, it is first determined whether or not authentication is necessary in step S21. This is carried out in order to perform authentication when the security level is switched as time passes, and if authentication is required, the user is authenticated as an authorized user by the MFP 100 while the authentication is not necessarily performed by the MFP itself but can instead be performed by an external authentication server 400 and so forth. The external authentication server 400 is connected to the network 200, and the MFP 100 may perform authentication only when a particular condition is satisfied, otherwise submit the authentication process to the external authentication server 400.

The determination of whether or not the external authentication is required is performed in step S22, and if not required, internal authentication is performed by the MFP 100 itself in step S23, otherwise external authentication is performed by the external authentication server 400 in step S24. Incidentally, in the case where authentication process is submitted to the external authentication server 400, the authentication methods as described above are common to both the MFP 100 and the external authentication server 400.

If authentication succeeds in step S25 the authentication process is completed, but if authentication does not succeed, for example, if input error occurs successively for three times, authentication is cancelled by locking out and/or notifying an administrator and so forth (step S26).

After the authentication for login is successfully finished as described above, the MFP 100 can be used.

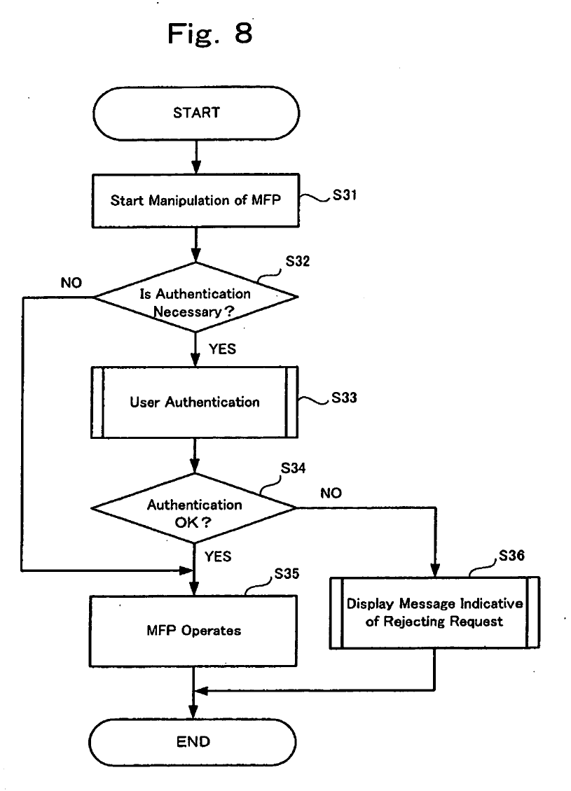

FIG. 8 is a flowchart showing the authentication process when the MFP 100 is manipulated. When the user start manipulating the MFP 100 to request to perform some process in step S31, it is determined in step S32 whether or not authentication is necessary. If the manipulation requires authentication, the user is authenticated to determine whether or not he is authorized to performs the process. In this case, user authentication is performed in step S33, and the MFP 100 operates corresponding to the manipulation in step S35 if the user is authorized in step S34 to make use of the MFP 100 in regard to the manipulation as a result of the authentication or if it is determined in step S32 that authentication is not required. Conversely, if the user is not successfully authenticated in step S34, a message is displayed on the manipulation unit 12 in order to indicate that the user has no authority to use the MFP 100 in regard to the manipulation and to reject the request, and then the process ends (step S36).

As has been discussed above, in accordance with the present invention, since the security level can be switched in accordance with time slots defined by times and days of week it is possible to balance the operating efficiency of users with the security by lowering the security level in a time slot, such as the work hours of a weekday, in which the frequency of use is high in order to make the user authentication simple and access-friendly, and by raising the security level in a time slot, such as a nonwork day, late at night, in which the frequency of use is low in order to enhance the measures against data leakage.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

It is claimed:

1. An image forming apparatus having multiple functions which include printing, copying and scanning, comprising:
an image processing unit that has a storage device capable of storing image data, and processes and outputs the image data stored in said storage device; and
a data protection unit that sets security levels respectively for time slots which are scheduled in advance, and places restrictions on the use of said image data in accordance with said security levels as set.

2. The image forming apparatus according to claim 1 wherein
said time slots are defined by days of a week and times, and said security levels are set high in a time slot in which said image forming apparatus is less frequently used and set low in a time slot in which said image forming apparatus is frequently used

3. The image forming apparatus according to claim 1 wherein
said data protection unit has an authentication unit for performing user authentication in order that the higher said security level, the authentication strength is set higher.

4. The image forming apparatus according to claim 3 wherein
said authentication unit perform user authentication selectively either by said image forming apparatus itself or by submitting the user authentication to an external authentication which is connectable to said image forming apparatus

5. The image forming apparatus according to claim 1 wherein
said data protection unit has a concealing unit which conceals said image data in order that the higher said security level, the concealment strength is set higher.

6. The image forming apparatus according to claim 5 wherein
said concealing unit comprises an encryption unit which encrypts said image data, and the higher said security level, the concealment strength by the encryption is set higher.

7. The image forming apparatus according to claim 5 wherein
said concealing unit has an erasing unit which erases said image data, and when said security level is high the image data stored in said storage device is erased after use.

8. The image forming apparatus according to claim 5 wherein
said concealing unit restricts the destination of scanned image data obtained by said image forming apparatus to a particular folder.

9. The image forming apparatus according to claim 1 wherein
said data protection unit restricts functions of said image forming apparatus which can be executed in accordance with said security level.

10. The image forming apparatus according to claim 9 wherein
said data protection unit restricts functions of said image forming apparatus which can be executed in accordance with said security level, and the restricted functions are changed in accordance with roles of users making use of said image forming apparatus.

11. An image forming apparatus having multiple functions which include printing, copying and scanning, comprising:
an image processing unit that has a storage device capable of storing image data, and processes and outputs the image data stored in said storage device;
a security level setting unit that sets security levels respectively for time slots which are scheduled in advance; and
a data protection unit that places restrictions on the use of said image data as the security level is high, and comprises at least an authentication unit that performs user authentication, an encryption unit that conceals said image data, and a restriction unit that restricts functions of said image forming apparatus which can be executed, wherein the higher said security level, the authentication strength and the encryption strength are set higher, and the restricted functions are changed in accordance with said security levels.

12. The image forming apparatus according to claim 11 wherein
said security level setting unit includes a timer, and sets said security levels high on the basis of time information in a time slot such as on a holiday or the like in which less persons use said image forming apparatus and the operation frequency is low.

13. The image forming apparatus according to claim 11 wherein
said data protection unit restricts the functions which can be executed in accordance with said security level, and the restricted functions are changed in accordance with roles of users making use of said image forming apparatus.

14. The image forming apparatus according to claim 11 wherein
said security level setting unit comprises an input unit that is used to input time slot information as defined by days of a week and times, and a storage unit that stores information about the security levels as set corresponding to said time slots respectively.

15. A data protection method for an image forming apparatus having a storage device capable of storing image data, comprising:
setting a security level for each of time slots which are scheduled in advance; and
placing restrictions on the use of said image data in accordance with said security levels as set when image data stored in said storage device is processed and output.

16. The data protection method according to claim 15, wherein
said time slots are defined by days of a week and times, and said security levels are set high in a time slot in which said image forming apparatus is less frequently used and set low in a time slot in which said image forming apparatus is frequently used.

17. A data protection method for an image forming apparatus having a storage device capable of storing image data, comprising:
providing a data protection unit that performs data protection, when image data stored in said storage device is processed and output, at least by performing user authentication and encryption of said image data and placing restrictions on functions which can be executed; and
setting a security level for each of time slots which are scheduled in advance;
wherein the higher said security level, the authentication strength and the encryption strength are set higher, and functions which can be executed are changed in accordance with said security level.
